(19) United States
(12) Patent Application Publication
(10) Pub. No.: US 2010/0011012 A1
(43) Pub. Date: Jan. 14, 2010

(54) Selective Compression Based on Data Type and Client Capability

(76) Inventor: Andrew R. Rawson, Austin, TX (US)

Correspondence Address: HAMILTON & TERRILE, LLP - AMD, P.O. BOX 203518, AUSTIN, TX, 78720, US

(21) Appl. No.: 12/169,897

(22) Filed: Jul. 9, 2008

(51) Int. Cl. G06F 17/30

(52) U.S. Cl. 707/101; 707/E17.009

(57) ABSTRACT

A method and apparatus are provided for generating virtual channels to selectively compress and deliver different data streams over a communication medium to a thin client receiving device by selecting a compression technique for each data stream that takes into account the data stream type, the bandwidth/latency characteristics of the communication channel, and the processing capabilities of the thin client that is the target or source of the data. By selectively compressing data streams within multiple virtual channels that are aggregated into a combined data stream to the receiving device, each individual data stream is individually compressed and packetized within its virtual channel based on the specific different delivery, bandwidth, latency and data fidelity requirements for that data stream, as well as the processing capability of the receiving device.

### BACKGROUND OF THE INVENTION

1. Field of the Invention

The present invention relates in general to the field of computing system networks. In one aspect, the present invention relates to a method and system for hosting graphics processing at a centralized location for remote users.

2. Description of the Related Art

There is increasing interest in using server-based computing to provide an information communication technology (ICT) infrastructure for delivering application functionality to end users to make them more effective and productive. Generally speaking, server-based computing is a solution which allows remote users to access desktops or single applications which are running on a central server. Access to the desktop or application is location and end-user device independent since the program execution and data processing occurs at a central server and is then conveyed as screen information using a data stream that is transmitted to the end user(s) using a remote display protocol. With server-based computing, applications can be delivered far more quickly than the traditional approach installing them locally on each end user's personal computer. There are also other benefits, such as centralized deployment of applications, consolidation and centralization of information technology resources, strengthening of security and compliance, and improvement of the user's computing experience in terms of consistent user access experience and improved mobility. However, there can also be disadvantages with server-based computing. For example, when a graphically intensive application is run on a central server, the end-user experience is impaired by if the graphics can not be successfully conveyed because of the channel bandwidth limitations in the remote display protocol (e.g., the RDP/ICA protocol) which is used to convey graphical information to the end user(s). While digital video compression techniques have been used to reduce the quantity of data used to represent video images and thereby reduce the bandwidth required to transmit digital video, such techniques are typically location and end-user device independent. Stated more generally, conventional schemes for distributing multiple data streams to one or more remote users fail to take into account the specific requirements of the data stream(s) being transmitted and the capabilities of the end user's device. Therefore, there is a need for an improved data stream distribution system architecture, apparatus and operating methodology which overcomes the problems in the art, such as outlined above. Further limitations and disadvantages of conventional processes and technologies will become apparent to one of skill in the art after reviewing the remainder of the present application with reference to the drawings and detailed description which follow.

### SUMMARY OF THE INVENTION

Broadly speaking, the present invention provides a system and methodology for hosting graphics processing at a central server location for use by a plurality of networked users. In selected embodiments, the central server establishes a connection with a client device and negotiates with the client device to determine the processing capabilities of the client device (or its subsystem components), the latency for transmit and receive signaling to the client device (or its subsystem components), and the available bandwidth for the (virtual) channel used to communicate with the client device (or its subsystem components). The central server assembles the negotiated information into a compression profile for the client device (or its subsystem components), and then uses the compression profile to selectively compress and packetize each data stream based on the processing capability of the receiving device (which may be anywhere from a personal computer to handheld personal communication device) and/or receiving device component that is to receive the data stream. In selected embodiments, multiple virtual channels may be established for each receiving device, where the central server uses the compression profile to define each virtual channel to provide different delivery, bandwidth, latency and data fidelity guarantees appropriate for the type of data stream being transmitted end-to-end. In addition or in the alternative, the central server may use the compression profile information to define separate (virtual) channels for different receiving devices that provide different delivery, bandwidth, latency and data fidelity guarantees appropriate for the type of data stream being transmitted to the different receiving devices. By tailoring the data stream transmission profiles to meet the requirements of the particular data stream and the processing capabilities of the receiving device, more than one graphics stream to be processed and distributed by a central location and multiplexed over a communication network to different remote users. In the multi-user network configuration, the central or host server makes more intelligent use of the data stream channel, thereby freeing additional bandwidth in the channel which can be used to deliver graphically intensive application output to the remote user (e.g., at the client or local machine or terminal) over a communication link (e.g., a dedicated cabling or a TCP/IP network).

In accordance with various embodiments of the present invention, a method and apparatus provide an application host server device for communicating a plurality of data streams to one or more client devices. In an exemplary embodiment, the data streams are communicated by assembling at the application host server device a compression profile for each data stream, where each compression profile specifies a compression limit for the corresponding data stream based upon what type of data is in the data stream (e.g., a data fidelity requirement for the data stream), one or more transmission requirements for the data stream (e.g., a bandwidth or latency requirement for the data stream), and a processing capability measure of the client device that will receive the data stream (e.g., an identification of system components that are required to process the data stream at a client device where the data stream is to be sent). For example, a first compression profile may be assembled for a first data stream that specifies a compression limit for the first data stream based upon what type of data is in the first stream, one or more transmission requirements for the first data stream, and a processing capability measure of the client device that will receive the first data stream, while a second compression profile is also assembled for a second data stream that specifies a compression limit for the second data stream based upon what type of data is in the second stream, one or more transmission requirements for the second data stream, and a processing capability measure of the client device that will receive the second data stream. In selected embodiments, the assembly of the compression profiles may include negotiating with the first client device to obtain, for each data stream, the processing capability measure of the first client device. With the compression profiles assembled, the host server device then sets up a virtual channel for each of the data streams based on the corresponding compression profile, selectively compresses each data stream based on the corresponding compression profile, and then sends the data streams over the corresponding plurality of virtual channels to at least a first client device over a communication network using a predetermined standard transport protocol. To provide an example of the selective compression process, a video data stream may be compressed with a lossy compression algorithm where the compression profile for the video data stream specifies a low data fidelity requirement, a high bandwidth transmission requirement, and a low processing capability measure of the client device that will receive the video data stream, while a print data stream may be compressed with a lossless compression algorithm where the compression profile for the print data stream specifies a high data fidelity requirement. When multiple data streams are sent to the same client device, the host server device can time multiplex the virtual channels together onto a signal data stream that is sent to the client device.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a simplified architectural block diagram of a server computer system which selectively compresses data streams based on data type and client capability in accordance with selected embodiments of the present invention.

FIG. 2 illustrates a signal communication protocol for selectively compressing and transmitting data streams over virtual channels to remote client devices.

FIG. 3 depicts an exemplary flow methodology for selectively compressing multiple data streams at a host device in accordance with selected embodiments of the present invention.

### DETAILED DESCRIPTION

A method and apparatus are provided for selectively compressing data streams at a central server location based on data type and client processing capability. In selected embodiments, a hosting graphics server is provided that uses virtual channels to selectively compress and deliver different data streams (e.g., compressed video, audio, and/or general input/output data, such as keyboard, mouse, printer data, etc.) having different bandwidth and latency requirements over a communication medium to a thin client receiving device which may also have different processing capabilities for different applications. At the hosting graphics server, the compression technique selected for each data stream is tailored to the data stream type, and takes into account the processing capabilities of the thin client that is the target or source of the data. For example, a first relatively lossy compression technique may be applied to a video data stream that is flowing from the hosting graphics server to a client having a low resolution display screen, while a second less lossy compression technique may be applied to the video data stream that is flowing to a client having a high resolution display screen. On the other hand, a lossless compression technique is applied to a printer data stream flowing down to a printer attached to the client, or to value data (e.g., data entry fields, passwords, user names, etc.) flowing from the client to the server, since data loss can not be tolerated with such data. By selectively compressing data streams within multiple virtual channels that are aggregated into a combined data stream to the receiving device, each individual data stream is individually compressed and packetized within its virtual channel based on the specific different delivery, bandwidth, latency and data fidelity requirements for that data stream, as well as the processing capability of the receiving device (which may be anywhere from a personal computer to handheld personal communication device).

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. Some portions of the detailed descriptions provided herein are presented in terms of algorithms and instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that, throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

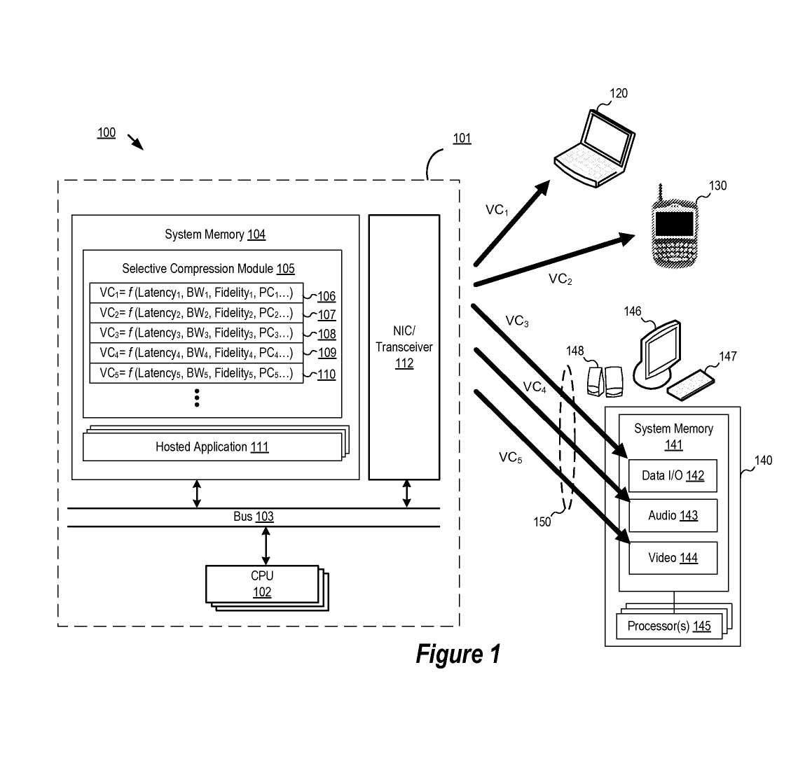

Turning now to FIG. 1, there is depicted a simplified architectural block diagram of a server computer system 100 which selectively compresses data streams based on data type and client capability in accordance with selected embodiments of the present invention. The depicted server computer system 100 uses a central server 101 to host application functionality for one or more networked users which each receive one or more data streams over one or more virtual channels at a receiving device, such as a laptop 120, handheld personal communication device 130 or personal computer 140.

The central server 101 includes one or more central processing units (CPU) 102, a system bus 103, system memory 104, and network communication transceiver device 112, such as a network interface controller (NIC). The CPU 102 may be implemented with one or more processor cores that implement the AMD64 instruction set architecture, or any other desired instruction set architecture, including but not limited to the x86 ISA, the PowerPC ISA, the ARM ISA, the SPARC ISA, the MIPS ISA, etc. In some embodiments, only one processor core may be included. In other embodiments, two or more processor cores may be included in a multi-core configuration. As for the system memory 104, it may be connected through a controller, and may be implemented as on-board or off-chip primary (L1), secondary (L2) and/or tertiary (L3) cache memory, DDR SDRAM module(s), Flash, RAM, ROM, PROM, EPROM, EEPROM, disk drive memory devices, and the like. The CPU 102 and system memory 104 are connected to one another over a high speed, high bandwidth bus or interface 103 (e.g., a PCI or PCI-E bus), which in turn is connected to the transceiver device 1 12. The bus 103 serves as a bridge, interface and/or communication bus that is responsible for communicating between the CPU 101, the system memory 104 and the transceiver device 1 12. Thus, the bus 103 may incorporate memory controller functionality to control the system memory 104. The bus 103 may also include a north bridge unit and/or south bridge unit, which may be a single integrated circuit chip, two or more chips in a multi-chip module, two or more discrete integrated circuits coupled to a circuit board, etc. As will be appreciated, other buses, devices, and/or subsystems may be included in the central server 101 as desired, e.g. caches, modems, parallel or serial interfaces, SCSI interfaces, etc. However, for clarity and ease of understanding, not all of the elements making up the central server 101 are described in detail. Such details are well known to those of ordinary skill in the art, and may vary based on the particular computer vendor and microprocessor type.

The system memory 104 stores the various hosted applications 111 that are run or executed on the central server 101, and then conveyed using one or more data streams that are transmitted to the end user(s) 120, 130, 140 using a remote display protocol. To assist with the data stream transmission, the system memory 104 also stores a selective compression module 105 which sets up multiple virtual channels (VC) for transmitting data to the end users. Any of a variety of compression techniques can be implemented at the selective compression module 105, such as by applying image compression and/or motion compensation to compress video information by reducing both spatial and temporal redundancy that is present in video frames. Indeed, there are a number of compression standards have been developed or are under development for compressing and decompressing video information, such as the Moving Pictures Expert Group (MPEG) standards for video encoding and decoding (e.g., MPEG-1, MPEG-2, MPEG-3, MPEG-4, MPEG-7, MPEG-21) or the Windows Media Video compression standards (e.g., WMV9). In addition, individual video compression techniques may be applied to reduce both spatial and temporal redundancy that is present in video frames, such as intraframe compression, interframe compression, spatial or block-based encoding using a discrete cosine transform (DCT) coding scheme, quantization, run-level encoding, variable length coding or using other entropy encoding technique, such as a Context-based Adaptive Binary Arithmetic Coding (CABAC), Context Adaptive Variable Length Coding (CAVLC) and the like. In operation, the selective compression module 105 retrieves the data stream to be transmitted from memory, and then compresses the data stream to reduce the quantity of data used to represent data stream information based on the associated data stream attributes, the transmission channel attributes, and/or the capability of the receiving device to process the data stream. Thus, compressed data stream may then be stored or buffered in the system memory 104 and/or sent to the transceiver device 112 for transmission to a remote user.

As configured by the selective compression module 105, each virtual channel provides different delivery, bandwidth, latency and data fidelity guarantees appropriate for the type of data stream being transmitted end-to-end. The selective compression module 105 compresses and packetizes the data stream within each virtual channel based on these guarantees and the processing capability of the receiving device. For example, the selective compression module 105 may define a first virtual channel VC₁ 106 for transmitting data to the laptop device 120, where the first virtual channel may be defined at least in part as a function of the latency (Latency₁) (e.g., transmit and/or return time) to the laptop device 120, the bandwidth (BW₁) of the transmission channel (e.g., data throughput rate) to the laptop device 120, the data fidelity requirement for the data stream being transmitted to the laptop device 120 (Fidelity₁), and/or the relevant processing capability (PC₁) of the laptop device 120. In similar fashion, the selective compression module 105 sets up a second virtual channel VC₂ 107 for transmitting data to the handheld device 130 that is a function of the latency (Latency₂) to the handheld device 130, the bandwidth (BW₂) of the transmission channel to the handheld device 130, the data fidelity requirement for the data stream being transmitted to the handheld device 130 (Fidelity₂), and/or the relevant processing capability (PC₂) of the handheld device 130, and so on for the other virtual channels (e.g., VC₃ 108, VC₄ 109, VC₅ 110, etc.).

To provide some illustrative examples, if a high definition video data stream from a graphics application 111 is being transmitted over a high bandwidth wireless channel to the laptop 120 which has a high resolution display screen, the selective compression module 105 may select a low loss compression algorithm 106 for the first virtual channel VC₁ since the video data stream is capable of being compressed with one or more video compression techniques and has a relatively low data fidelity requirement, while the receiving device 120 has the processing capability to display the high definition video data stream. On the other hand, if a high definition video data stream from a graphics application 111 is being transmitted over a low bandwidth wireless channel to the handheld device 130 which has a low resolution display screen, the selective compression module 105 may select a relatively lossy compression algorithm 107 for the second virtual channel VC₂. The selective compression module 105 selects a higher loss compression algorithm for the second virtual channel VC₂ because the compressible video data stream has a relatively low data fidelity requirement and because the receiving device 130 does not have has the processing capability to display the high definition video data stream. However, if a printer data stream from a word processing application 111 is being transmitted over a high bandwidth hard-wired channel to the desktop 140 which has an attached printer (not shown), the selective compression module 105 may select a lossless compression algorithm 108 for the third virtual channel VC₃ since the printer data stream is relatively small and has a high data fidelity requirement, while the receiving device 140 has the processing capability (e.g., the attached printer) to handle the printer data stream.

It will be appreciated that more than one virtual channel may be set up for a particular receiving device based upon the specific data stream characteristics and associated processing capabilities at the receiving device. This is shown in FIG. 1 with the three virtual channels VC₃ 108, VC₄ 109, VC₅ 110 which are respectively being streamed to a data input/output module 142 (e.g., a printer output), an audio module 143 (e.g., a speaker output), and a video module 144 (e.g., an audio/video display output). As this example shows, the central server 101 is sending multiple different data streams over multiple different virtual channels so that a printer data output stream is being sent over virtual channel VC₃, an audio data stream is being sent over virtual channel VC₄, and a video data stream is being sent over virtual channel VC₅. Based on the different bandwidth and latency requirements for each data stream, as well as the receiving device's ability to process each data stream, the selective compression module 105 tailors the compression techniques that applied to each data stream. For example, a lossy compression technique 110 may be appropriate for video flowing down from the central server 101 to the client 140 which has a low resolution display device 146. However, lossless compression technique 108 is applied to the data flowing down to an attached printer (not shown) at the client 140. In addition, the type of compression algorithm used by the selective compression module 105 should take into account the processing capabilities of the thin client that is the target or source of the data. Thus, a lossy compression technique 109 may be appropriate for stereo audio flowing down to the client 140 having auidio speakers 148 that do not support stereo audio playback. Once the selective compression module 105 chooses the appropriate compression for each data stream, the virtual channels VC₃, VC₄, VC₅ may be aggregated by time multiplexing the virtual channels together into one data stream 150 which may be carried to the receiving device 140 over a communication mechanism (e.g., wirelessly or over the Internet) using a predetermined standard transport protocol stack (e.g., TCP/IP).

With the selective compression module 105, the central server 101 may be used as a graphics hosting server 101 to deliver a remote PC experience to one or more remote users 120, 130, 140 by creating and rendering each user's computing experience at the graphics hosting server 101. In operation, the graphics hosting server 101 performs all of the graphics processing for the remote user(s) 120, 130, 140, and then individually compresses the graphics data streams to set up virtual channels based on the channel characteristics and processing capability at the remote user(s) 120, 130, 140. The graphics processing experience (inputs, outputs) for each remote user is delivered to the remote user at the client, local machine/terminal over a medium (such as dedicated cabling or a network) using a remote display protocol (e.g., RDP, ICA, VNC, RGS and other proprietary schemes). The remote experience consists of providing pertinent input and output functions for the graphics hosting server 101 at the client (e.g., display 146 and keyboard 147 at desktop 140). Such input and output functions may include the display of the host's output to a local screen or screens, keyboard and mouse input from the client machine sent to the host, audio input and output from/to the user at the client machine sent to/from the host, and general purpose I/O, such as serial or parallel ports, but more typically USB ports.

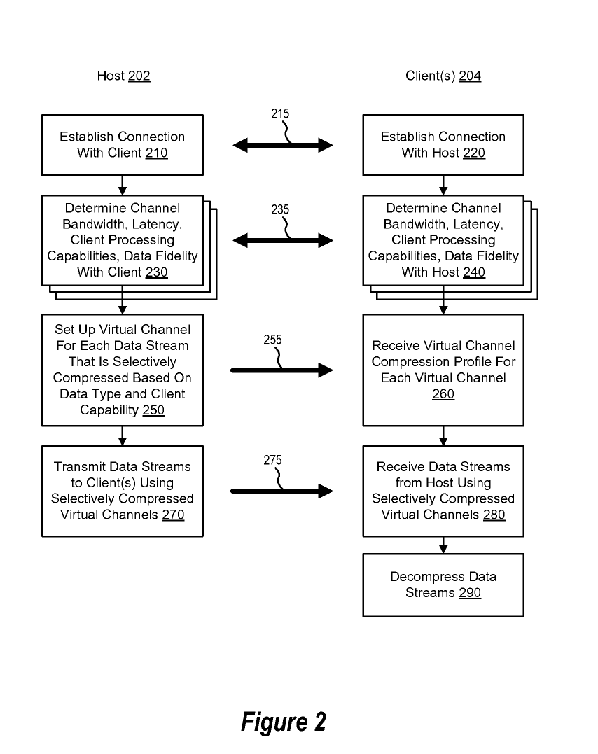

Turning now to FIG. 2, there is depicted an exemplary signal communication protocol for selectively compressing and transmitting data streams over virtual channels to remote client devices. In the depicted protocol, a host device 202 establishes a connection with one or more client devices 204 at steps 210, 220 by exchanging connection setup messages 215. Once a client connection is established, the host 202 and client(s) 204 negotiate or otherwise determine the relevant characteristics of the data stream, the transmission channel, and the receiving device by exchanging profile messages 235. For example, the host 202 at step 230 determines the bandwidth and/or latency characteristics of the available communication channel to the client 204, as well as the data fidelity requirements for the subject data stream, and may also negotiate the client processing capabilities of the client 204. Simultaneously at step 240, the client 204 may also assist with determining the bandwidth and/or latency characteristics of the available communication channel, as well as the data fidelity requirements for the subject data stream, and may also negotiate the client's processing capabilities with the host 202. Examples of client processing capabilities include, but are not limited to, CPU speed, memory size, video graphics capabilities, display resolution and aspect ratio, available I/O devices, etc. As indicated by the recessed boxes, step 230 may be performed multiple times at a host 202 for each data stream sent to a client 204. Likewise, when a client 204 is to receive multiple data streams, step 240 may be performed multiple times at the client 204 for each data stream.

Once the relevant data stream, transmission channel, and client processing capability characteristics are assembled, the host 202 sets up a virtual channel for each data stream that is selectively compressed at step 250. The compression that is selected for the virtual channel is based on the data type, the channel characteristics, and the client's ability to fully process and/or display the data stream. To enable the client 204 to decompress the data stream sent over the virtual channel, the host 202 sends a virtual channel compression profile message 255 which is received and processed by the client 204 at step 260. At this point, the host 202 and client 204 are configured to transfer data stream(s) 275 to the client(s) 204 using the selectively compressed virtual channels, as shown at steps 270, 280. At the client 204, the data stream received over the virtual channel may be decompressed (step 290) based on the previously received virtual channel compression profile.

The example signal communication protocol described herein may be included as part of a standardized set of rules for data representation, signaling, authentication and error detection required to reliably send information over a communications channel. Thus, it will be appreciated that additional communication protocol features (such as synchronization, error detection and correction, acknowledgment messages, etc.) may be used to ensure reliable and effective interchange of data over an imperfect communication channel.

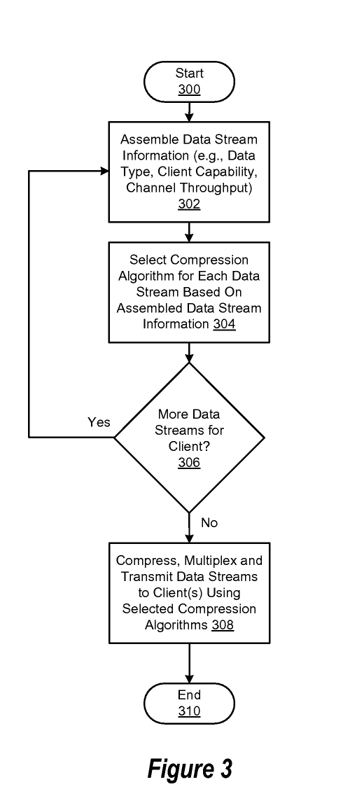

To illustrate the selective compression operations performed at the central host server, reference is now made to FIG. 3 which depicts an exemplary flow methodology for selectively compressing multiple data streams at a host device in accordance with selected embodiments of the present invention. The method begins at step 300, such as when a data stream is to be transmitted to a receiver. At step 302, the host device assembles data stream information which will be used to determine which compression algorithm is used for the data stream. For example, the host device can determine from the type of data stream what the fidelity requirement is for the data stream, either in the form of a qualitative value or a threshold or percentage value specifying what percentage of the original bytes should be preserved. The host device can also determine the ability of the client to process the data stream being sent, such as by negotiating with the client to determine the client's display type (e.g., color, video resolution, screen size, etc.), supported languages (e.g., Java, XML, HTML, etc.), processor power, memory configuration, graphics capabilities (e.g., shapes, pels, JPG, etc.), available input/output devices, etc. In addition, the host device can determine the channel throughput characteristics for the channel to the receiver, such as by exchanging test messages to determine the bandwidth and latency characteristics for the channel.

At step 304, the host device selects a compression algorithm for each data stream based on the assembled data stream information. The host device has at least one compression algorithm, but typically a plurality of compression algorithms that can be applied to a data stream. The host device selects a compression algorithm for a data stream based upon the combination of the requirements of the data stream (e.g., the fidelity requirement or degree of loss if the compression algorithm results in loss of information), the bandwidth and latency characteristics of the communication channel to the client, and the ability of the client to use or process any part of the data stream that might be lost through compression. The host device can also use other selection criteria, such as the amount of size reduction likely to result from the compression, the host device resources which are available for compression, etc. The host device can use a performance monitor to monitor the communication channel characteristics, the data stream requirements, the client processing capability, and other selection criteria. As will be appreciated, performance monitors can be implemented, for example, in software using standard programming languages (e.g. Java, C, C++, assembly, machine language, and others) available from a wide variety of vendors.

Any desired multi-criteria selection algorithm may be used to choose a compression algorithm for a data stream. For example, the data stream may have a data fidelity parameter associated with it indicating the degree of loss which can be tolerated. If the data fidelity parameter indicates that no loss can be tolerated (such as can occur with print data streams or keypad input data streams), the host device will select a lossless compression algorithm, such as run length encoding, dictionary coding, entropy encoding, dynamic Markov compression, context mixing, block-sorting compression, and the like. On the other hand, if the data fidelity parameter indicates that loss can be tolerated (such as can occur with audio and video data streams), the host device will select a lossless compression algorithm or a lossy compression algorithm, such as a frequency transform compression (e.g. discrete cosine transform), fractal compression, wavelet compression, vector quantization, linear predictive coding, modulo-n coding, and the like. There may also be a client process capability parameter to indicate how much loss can be tolerated, given the processing capabilities at the client. For example, if the client has a high processing capability (such as a high speed processor or high resolution graphic display system), the client process capability parameter indicates to the host device that a relatively low loss compression algorithm should be selected, (e.g., MPEG-2 compression for a video data stream). However, if the client has a relatively low processing capability (such as a low speed processor or low resolution graphic display system), the client process capability parameter indicates to the host device that a relatively lossy compression algorithm should be selected, (e.g., MPEG-1 compression for a video data stream). The host device also applies the remaining selection criteria to choose the compression algorithm that results in the smallest data size that fits within the bandwidth and latency characteristics of the communication channel, that meets the data fidelity requirements for the data stream, and that, when reversed, produces a data stream that can be fully utilized or processed at the client.

Once the compression algorithm is selected for the data stream, the host device determines if there are any remaining data streams to be transmitted to the client. If there are additional data streams (affirmative outcome to decision 306), the sequence is repeated until there are no more data streams to be processed (negative outcome to decision 306), at which point the host device compresses the data stream(s) using the selected compression algorithms, multiplexes the results together into an aggregate data stream and transmits the aggregate data stream to the client (step 308). As seen from the foregoing, the packet size and compression technique may be adapted for each of the N different data streams by taking into account the combination of the bandwidth and latency characteristics of the communication media, the requirements of the particular data stream, and the processing capabilities of the receiving device.

By now it should be appreciated that there is provided herein a method, apparatus and system for selectively compressing data streams based on data type and client capability. Selected embodiments may be implemented as article of manufacture having at least one recordable medium having stored thereon executable instructions and data which, when executed by at least one processing device, cause the at least one processing device to assemble a plurality of data streams for transmission to one or more target client devices, evaluate each data stream to determine a plurality of transmission requirements for the data stream, establish a connection with each target client device to determine one or more processing capabilities of the target client device, and selectively compress and transmit each data stream based on the plurality of transmission requirements for the data stream and based on the one or more processing capabilities of the target client device where the data stream is to be transmitted. As will be appreciated, each data stream may be selectively compressed and transmitted by sending the plurality of data streams over a corresponding plurality of virtual channels to at least a first target client device, and/or by time multiplexing the plurality of data streams over a corresponding plurality of virtual channels to a first target client device. In addition, each data stream may be evaluated by determining a data fidelity requirement, a bandwidth requirement, and/or a latency requirement for each data stream.

In another form, there is provided a hosted graphics system which includes a central server device for performing graphics processing for a plurality of remote client devices. The central server device is configured to selectively compress different graphics data streams having different bandwidth and latency requirements over a communication medium to at least a first remote client device, where each graphics data stream is compressed into a compressed graphics data stream based on the bandwidth and latency requirements of the graphics data stream and based on the one or more processing capabilities of the remote client device where the graphics data stream is to be transmitted. In selected embodiments, the central server device is configured to transmit a plurality of compressed graphics data streams over a corresponding plurality of virtual channels to a first remote client device, and in other embodiments, is configured to transmit a plurality of compressed graphics data streams over a corresponding plurality of virtual channels to a plurality of remote client devices

As described herein, selected aspects of the invention as disclosed above may be implemented in hardware or software. Thus, some portions of the detailed descriptions herein are consequently presented in terms of a hardware implemented process and some portions of the detailed descriptions herein are consequently presented in terms of a software-implemented process involving symbolic representations of operations on data bits within a memory of a computing system or computing device. The software discussed herein may include script, batch, or other executable files. The software may be stored on a machine-readable or computer-readable storage medium, and is otherwise available to direct the operation of the computer system as described herein and claimed below. In one embodiment, the software uses a local or database memory to implement the data transformation and data structures so as to improve the generation of attribute-based rules. The local or database memory used for storing firmware or hardware modules in accordance with an embodiment of the invention may also include a semiconductor-based memory, which may be permanently, removably or remotely coupled to a microprocessor system. Other new and various types of computer-readable storage media may be used to store the modules discussed herein. Additionally, those skilled in the art will recognize that the separation of functionality into modules is for illustrative purposes. Alternative embodiments may merge the functionality of multiple software modules into a single module or may impose an alternate decomposition of functionality of modules. For example, a software module for calling sub-modules may be decomposed so that each sub-module performs its function and passes control directly to another sub-module. These descriptions and representations are the means used by those in the art to convey most effectively the substance of their work to others skilled in the art using both hardware and software.

The particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A method for communicating a plurality of data streams from an application host server device, comprising:
assembling a plurality of compression profiles for a corresponding plurality of data streams at the application host server device, where each compression profile specifies a compression limit for the corresponding data stream based upon what type of data is in the data stream, one or more transmission requirements for the data stream, and a processing capability measure of the client device that will receive the data stream;
setting up, at the application host server device, a virtual channel for each of the plurality of data streams based on the compression profile corresponding to the data stream;
selectively compressing each of the plurality of data streams based on the corresponding compression profile; and
sending the plurality of data streams over the corresponding plurality of virtual channels to at least a first client device.

2. The method of claim 1, where assembling a plurality of compression profiles comprises:
assembling a first compression profile for a first data stream at the application host server device, where the first compression profile specifies a compression limit for the first data stream based upon what type of data is in the first stream, one or more transmission requirements for the first data stream, and a processing capability measure of the client device that will receive the first data stream; and
assembling a second compression profile for a second data stream at the application host server device, where the second compression profile specifies a compression limit for the second data stream based upon what type of data is in the second stream, one or more transmission requirements for the second data stream, and a processing capability measure of the client device that will receive the second data stream.

3. The method of claim 1, further comprising time multiplexing a plurality of virtual channels together onto a signal data stream that are sent to the first client device.

4. The method of claim 1, where sending the plurality of data streams comprises sending the plurality of data streams over a communication network using a predetermined standard transport protocol.

5. The method of claim 1, where the compression limit for each data stream comprises a data fidelity requirement for the data stream.

6. The method of claim 1, where the one or more transmission requirements for the data stream comprises a bandwidth requirement for the data stream.

7. The method of claim 1, where the one or more transmission requirements for the data stream comprises a latency requirement for the data stream.

8. The method of claim 1, where the processing capability measure comprises an identification of system components that are required to process the data stream at a client device where the data stream is to be sent.

9. The method of claim 1, where assembling the plurality of compression profiles comprises negotiating with the first client device to obtain, for each data stream, the processing capability measure of the first client device.

10. The method of claim 1, where selectively compressing each of the plurality of data streams comprises:
compressing a video data stream with a lossy compression algorithm where the compression profile for the video data stream specifies a low data fidelity requirement, a high bandwidth transmission requirement, and a low processing capability measure of the client device that will receive the video data stream; and
compressing a print data stream with a lossless compression algorithm where the compression profile for the print data stream specifies a high data fidelity requirement.

11. An article of manufacture having at least one recordable medium having stored thereon executable instructions and data which, when executed by at least one processing device, cause the at least one processing device to:
assemble a plurality of data streams for transmission to one or more target client devices;
evaluate each data stream to determine a plurality of transmission requirements for the data stream;
establish a connection with each target client device to determine one or more processing capabilities of the target client device; and
selectively compress and transmit each data stream based on the plurality of transmission requirements for the data stream and based on the one or more processing capabilities of the target client device where the data stream is to be transmitted.

12. The article of manufacture of claim 11, where the executable instructions and data cause the at least one processing device to selectively compress and transmit each data stream by sending the plurality of data streams over a corresponding plurality of virtual channels to at least a first target client device.

13. The article of manufacture of claim 11, where the executable instructions and data cause the at least one processing device to selectively compress and transmit each data stream by time multiplexing the plurality of data streams over a corresponding plurality of virtual channels to a first target client device.

14. The article of manufacture of claim 11, where the executable instructions and data cause the at least one processing device to selectively compress and transmit each data stream by sending the plurality of data streams over a communication network using a predetermined standard transport protocol.

15. The article of manufacture of claim 11, where the executable instructions and data cause the at least one processing device to evaluate each data stream by determining a data fidelity requirement for each data stream.

16. The article of manufacture of claim 11, where the executable instructions and data cause the at least one processing device to evaluate each data stream by determining a bandwidth requirement for each data stream.

17. The article of manufacture of claim 11, where the executable instructions and data cause the at least one processing device to evaluate each data stream by determining a latency requirement for each data stream.

18. A hosted graphics system, comprising:
a central server device for performing graphics processing for a plurality of remote client devices, where the central server device is configured to selectively compress different graphics data streams having different bandwidth and latency requirements over a communication medium to at least a first remote client device, where each graphics data stream is compressed into a compressed graphics data stream based on the bandwidth and latency requirements of the graphics data stream and based on the one or more processing capabilities of the remote client device where the graphics data stream is to be transmitted.

19. The hosted graphics system of claim 18, where the central server device is configured to transmit a plurality of compressed graphics data streams over a corresponding plurality of virtual channels to a first remote client device.

20. The hosted graphics system of claim 18, where the central server device is configured to transmit a plurality of compressed graphics data streams over a corresponding plurality of virtual channels to a plurality of remote client devices.
